(19) United States
(12) Patent Application Publication
(10) Pub. No.: US 2005/0216450 A1
(43) Pub. Date: Sep. 29, 2005

(54) Information search system

(75) Inventors: Takashi Yokohari, Iwai (JP); Hiromitsu Tokisue, Chiyoda (JP); Ichiro Nishigaki, Ishioka (JP); Norihiko Nonaka, Chiyoda (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 11/011,028

(22) Filed: Dec. 15, 2004

(30) Foreign Application Priority Data
Mar. 25, 2004 (JP) 2004-088309

(51) Int. Cl. G06F 17/30

(52) U.S. Cl. 707/3

(57) ABSTRACT

Within an information search system, for plural numbers of databases as being a search target, an index database is built up by virtually unifying the databases of the search target, in relation to an index thereof, and search is conducted onto those databases through that index database. For preceding this process, there is provided a relationship means for relating an index within of the index database to an index of the databases as the search target, within the information search system.

The present application claims priority from Japanese application JP2004-88309 filed on Mar. 25, 2004, the content of which is hereby incorporated by reference into this application.

### BACKGROUND OF THE INVENTION

The present invention relates to an information search system for searching information over plural numbers of databases.

Accompanying with widely spreading of computers, large varieties of databases are established, independently, and a large amount of information is stored in each of those databases. For this reason, it is important to search out useful information for a user, effectively, from such the databases in plural numbers thereof, each being provided independently, thereby to be utilized by the users. For achieving the search upon information with high efficiency, in particular, over the plural numbers of databases, it is already known a method, in which data are combined or unified, virtually, each being indicated with an index owned by each of the plural numbers of databases, and thereby newly building up an index database storing the information for use in searching (i.e., search information). In such the search of this method, the search is executed with using the index database, which is newly built up.

Other method, for treating or handling the databases integrally, is also described in Japanese Patent Laying-Open No. Hei 11-96054 (1999), for example. In this publication, a transmissive or permeable access to data on the plural numbers of databases can be achieved, but with using a less amount of consumption of resources. For this reason, in the search method described in that publication, a virtual object management portion of a virtual object unifying server receives a request for reference from a business-use application to a common object instance, together with a designation of variables for specifying a range of the common object instance that requests the reference. And, in accordance with a common object model that was defined in advance, the common object instance is produced. Data on each database system are gathered or integrated to the common object instance that is produced, and a referring result requested is turned back. In this instance, the data integrated to the common object instance are only those, each having the designated variable as an attribute value thereof.

Further other method is also described, for example, in Japanese Patent Laying-Open No. 2001-101065 (2001), for treating or handling the databases, integrally. With such the method as was describe in this publication, it is possible to obtain a decentralized environment where an object can be handled, equally, but without consciousness of the storage location thereof within the databases and/or servers. For this reason, in this search system, the business-use application is built up by installing a logical object thereof onto a logical layer, while the common object is produced on a real layer corresponding to the logical object. And, a connector ID is obtained by referring to a first conversion table with an aid of a logic ID. The common object operates the data with using a service provided through an interface by a physical layer. The physical layer obtains a physical ID by referring to a second conversion table with an aid of the logic ID. Thus, with using this physical ID, a real object of the database can be read out, and a connector object is produced from the real object, and then the connector object produced is linked to the logical object via the common object. In that instance, the search and renewal are made upon the data lying over the plural numbers of the databases and the computers, at once, while installing plural numbers of the logical objects onto the logical layer.

Conventionally, within such the integrated search system, determination is made in advance upon the database assumed to include useful information therein (or, called by a “substantial database”), and then, the index database is built up, fixedly, on the database that is determined, by a system designer. For this reason, it is difficult for a user using the system, to add a database, newly, to be a target of search; i.e., it is impossible to extend the database targeted, easily.

### BRIEF SUMMARY OF THE INVENTION

According to the present invention, achieved by taking the drawbacks of the above-mentioned conventional arts into the consideration, an object thereof is to provide an information search system, applying therein an index database of virtually integrating plural numbers of databases, wherein a database at a search target can be added, easily, thereby increasing an expandability thereof.

For accomplishing the object mentioned above, according to the present invention, there is provided an information search system, comprising: plural numbers of databases, as being a search target; an index database, being built up by virtually unifying the plural numbers of the databases, in relation to an index thereof; and a relationship means for relating an index within said index database to an index within said databases as the search target, wherein search is conducted onto said databases through said index database, and said index database is build up through the relationship made in said relationship means.

Also, according to the present invention, in the information search system as described in the above, a portion of said indexes of said index database is changeable into non-display in condition, selectively, when displaying a search result obtained within said index database. Further, wherein display can be made on an existence or non-existence of an access qualification to said databases as the search target, when displaying a search result obtained within said index database. Further, wherein selection can be made on whether a personal-use database be included or not, within a target of obtaining indexes for said index database, if there are common-use databases to be used in common by a user group of plural numbers of users and also a personal-use database for use by an individual user, within said databases. And, wherein narrowing on the databases of the search target can be made for an each user, within said databases of the search target.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a block diagram for showing an information search system, according to an embodiment of the present invention;

FIGS. 2 to 6 are views, for explaining each process within the information search system shown in FIG. 1, respectively; and

FIG. 7 is a block diagram for showing the information search system, but according to other embodiment of the present invention.

### DETAILED DESCRIPTION OF THE INVENTION

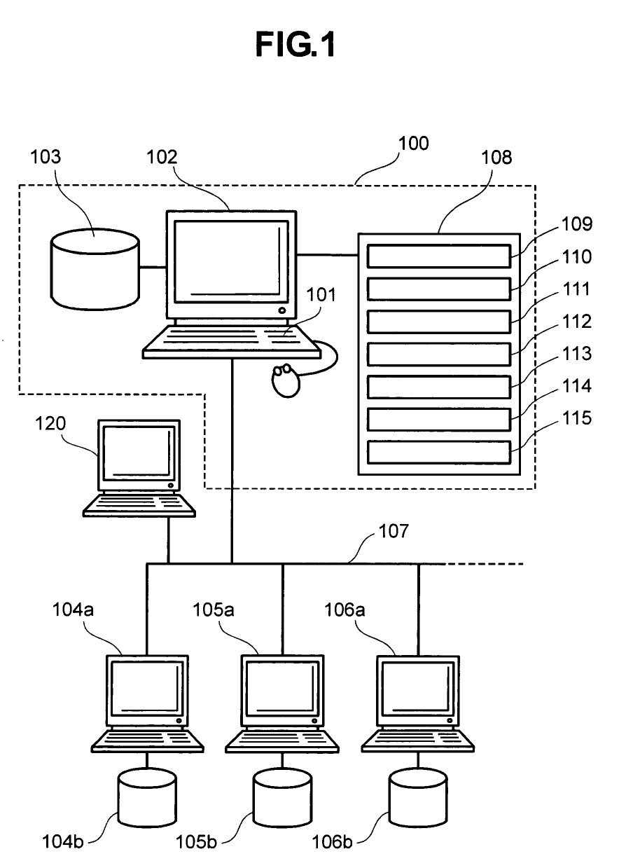

Hereinafter, an information search system, according to an embodiment of the present invention will be fully explained by referring to the attached drawings, i.e., FIGS. 1 to 6. First, FIG. 1 is a block diagram of the information search system. The information search system is constructed to be a computer network, comprising plural numbers of data processing apparatuses 100, 104a, 105a, 106a and 120, etc., being connected with one another through a communication network 107. The data processing apparatus 100 is built up with a server or the like, which can be used by a computer for an individual user, or can be used by plural numbers of users, in common, and it is installed with a program for use of an information search system. Other data processing apparatuses 104a, 105a and 106a are also the servers, in the similar manner, each of which can be used by a computer for an individual user, or can be used by plural numbers of users, in common, wherein in particular, the data processing apparatus 104a has a database 104b, the data processing apparatus 105a a database 105b, the data processing apparatus 106a, and a database 106b, respectively, and those databases make up a target of search. The data processing apparatus 120 is that for a specific user, who uses the present information search system, and it is used for displaying a search operation and/or a search result thereon within the present information search system.

The data processing apparatus 100 comprises an input device 101, which is constructed with a keyboard and/or a mouse, etc., an display device 102 for use of outputting, an index database 103, and a data processing portion 108. Onto the data processing portion 108 is installed a program for use in the information search system. That program for use in the information search system includes an index database building-up portion 109, a search potion 110, a relationship portion 111, a non-displaying portion 112, an access qualification display portion 113, a local set-up portion 114, and a search target set-up portion 115, each being provided as a means for achieving the respective function thereof.

Within such the data processing portion 108, a user of the present system sets up an index to be used in the present information search system, arbitrarily, and within the relationship portion 111, an each index is related to this index for system, which is obtained from the plural numbers of databases, as being the search target. And, upon the basis of this relationship, the index database building up portion 109 builds up the index database 103.

Herein, the index is a description portion of characterizing an each record within a data file, which is accumulated within the database as being the search target (i.e., a substantial database), namely, it designates a field of characterizing the record. Accordingly, the index that can be obtained from the substantial database is a characteristic field, which can be obtained from the record within the substantial database, while the index for use of the system within the index database is a field of the index database.

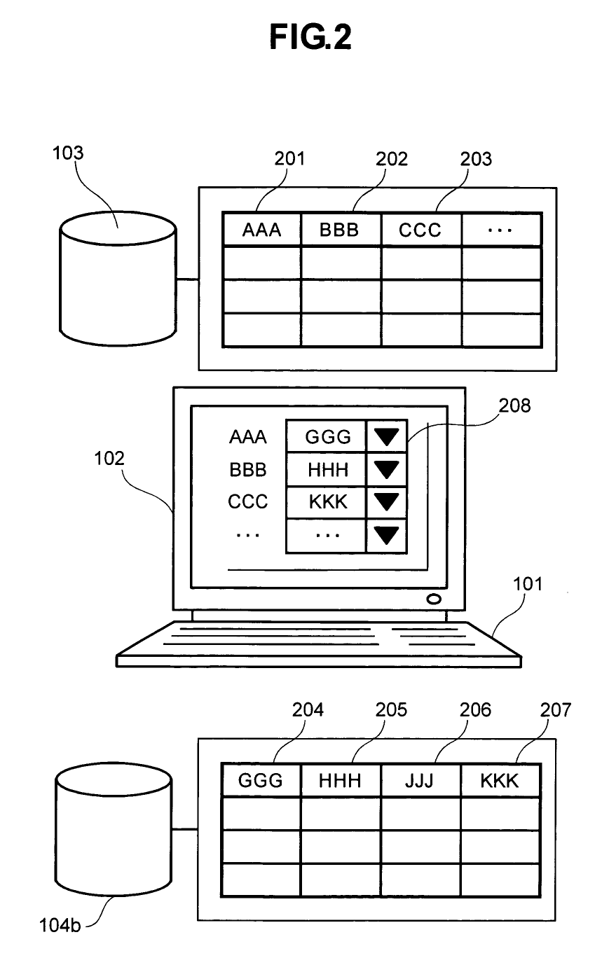

Hereinafter, explanation will be made about the function of each the function means mentioned above. First, explanation will be given about the function of building up a relationship of the index, which is conducted within the relationship portion 111. FIG. 2 shows an example of the processes for relating the index of the substantial database (i.e., this is the field for characterizing the record within the substantial database, as was mentioned above) to the index within the index database 103 (i.e., this is the field within the index database, as was mentioned above), while visualizing it. The index database 103 has indexes 201, 202, 203 . . . for system. The index 201 expressed by “AAA” is a “Title”, for example, the index 202 expressed by “BBB” is a “Category”, for example, and the index 203 expressed by “CCC” is a “Producer”, and further other than those, there may be used “Renewal Date”, “Text”, etc., for example, as a main index within the index database. On the other hand, the substantial database 104b has indexes 204 to 207.

When starting the operation of the relationship portion 111, a selection screen 208 is displayed on the display device 102. Then, selection and determination are made on, to which one of the indexes 204 to 207 should be made the relationship, for those indexes 201, 202, 203 . . . , upon this selection screen 208. For example, assuming that “AAA” is the “Title”, while assuming that the index “GGG” of the substantial database 104b is a “Subject”, being the expression corresponding to that “Title”, then the index “GGG” is related to the index “AAA”. Such the operation is conducted for each of the indexes within the index database, and further for all of the databases as being the search target.

With using the relationship portion 111 as was mentioned above, it is possible to build up the relationship of the indexes within the databases, to the indexes for system, which are set up arbitrarily. And, via this relationship, it is possible for a user to build up the index database, on which the indexes, each being expressed uniquely within the plural numbers of the substantial databases, can be handled in uniformity. Namely, it is possible to build up the index data, freely, which can absorb the difference in the expression of the indexes, being unique for each of the substantial database. In this manner, it is possible to build up a free index database, by a user, thereby obtaining the databases of the search target, to which an addition of database can be made, easily, as well as, being superior in the expandability thereof.

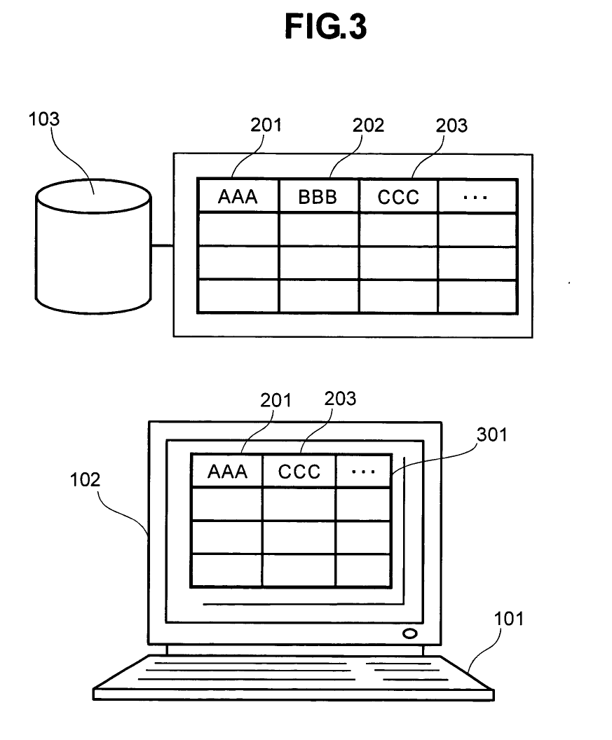

Next, explanation will be given about the function of the non-displaying portion 112 mentioned above. The non-displaying portion 112 turns one (1) or more of the indexes, each being preset for each user, not to be displayed when displaying a list of the search results obtained from the index database. An example of this is shown in FIG. 3. The index database 103 has the indexes 201, 202, 203 . . . , however if the index 202 among them is made a target of non-displaying in relation to a specific user, for example, then upon the display screen for showing the search result made by that user, the index 202 is turned to non-displaying. Herein, it is important that also the contents of the index 202 turned to non-displaying are not used in the search of information on the substantial database. The present function is useful, in particular, in a case when the contents of the index 202 are necessary for conducting the information search, but it is desired to avoid them from being published. With this function, for the user, it is possible to know that the information exists, but separating from accessibility to the substantial database.

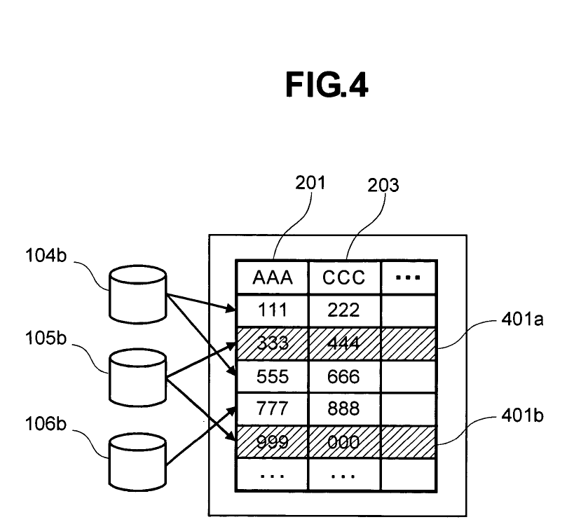

Next, explanation will be made about the function of the access qualification display portion 113 mentioned above. The access qualification display portion 113 displays the qualification about accessibility to the substantial database when displaying a list of the search results obtained from the index database. An example thereof is shown in FIG. 4. Assuming that the user, who is now executing the search process, has no qualification to access the database 105b, among the databases 104b, 105b and 106b, making up the search target of the present system, then the search result is displayed separating from the others, as are the columns shown by 401a and 401b. With those, it is possible for the user to know that the information can be found even within the database, onto which the user her/himself has no qualification of access, and therefore she/he can refer the data that is searched out, through asking a manager of the database to give the qualification to her/him, if it is necessary. Further, in the present example, there is explained the qualification for access, by a unit of the database, however it is also possible to make up such the construction, that the search result can be displayed separating from the others depending upon the qualification of access, in the similar manner, in relation to the respective data within the databases.

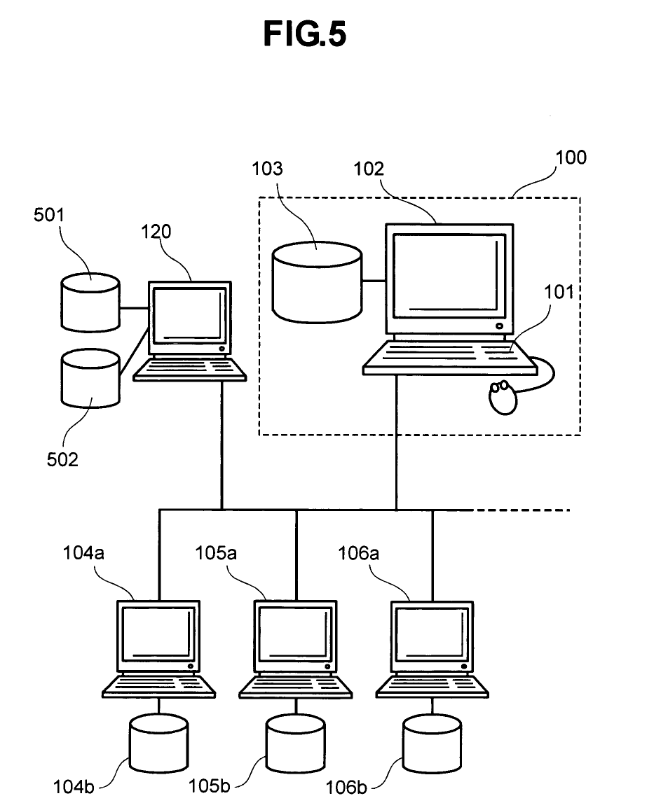

Next, explanation will be given about the function of the local set-up portion 114 mentioned above. FIG. 5 shows the system configuration when using the function of the local set-up portion 114. The local set-up portion 114 is used, in particular if the user, being one (1) of a group of users who are using the present system, owns a personal-use database 501 for an individual within a personal-use data processing apparatus 120, for the purpose of making selection on whether that personal-use database 501 should be included, or not, into the target for obtaining the index with using the index database 103 for common-use by the user group, thereby achieving the set-up thereof. With provision of such the function, even under the environment of being used by plural numbers of users, it is possible to conduct the search, with much high safety, upon the information, even under the condition of mixing up the personal data and the common data together, while keeping the security thereof. Herein, in the present embodiment, the user has her/his own personal-use index database 502, too. This personal-use index database 502 is built up through the similar operation to that of the common-use index database 103, for each of the users, and it is build up by the user as a private one in a case when she/he tries to include the index private to that user into the index database. Enabling to build up such the personal-use index database 502 is also one of the features obtained according to the present invention, and this is effective for the purpose of conducting the search of information, with much high safety, even under the environment of mixing up the personal data and the common data together, while keeping the security thereof. The owner of such the personal-use index database 502 is able to search or find out the information from both the personal-use index database 502 and the common-use index database 103. However, the local index database is provided on the personal data processing apparatus 120 for the user, in the present embodiment, but it may be position on the common-use data processing apparatus 100.

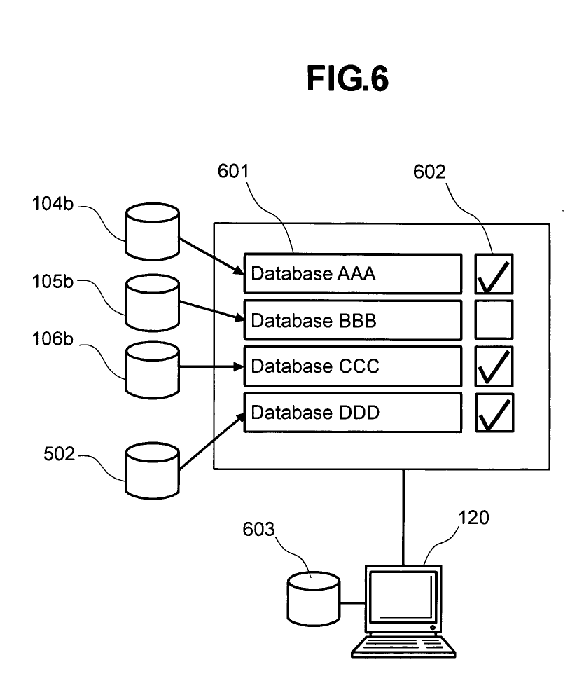

Next, explanation will be give about the function of the search target set-up portion 115 mentioned above. The search target set-up portion 115 is used for each of the users to select or narrow up the databases on the search target, arbitrarily, among the plural numbers of databases, which are set to be the search targets, i.e., index obtaining targets, in the present system. An example of condition of that operation is shown in FIG. 6. In the example of the figure, the search target is built up with the databases 104b, 105b and 106b, each of which stores the information common to the user group of the present system, and also the personal-use database 502, which is owned by one of the users of the user group. Those databases are displayed in the form of a list thereof, as shown by a reference numeral 601, and among of those, the user picks up the database that she/he tries to include into the search target or excluded therefrom, so as to designate it. The information relating to the selection of the databases is stored into an environmental file storage portion 603 of the data processing apparatus, which is used by each of the users, etc. Allowing each of the users to select or narrow the databases of the search target avoids the search made up to information clearly unnecessary, thereby enabling the effective search thereof.

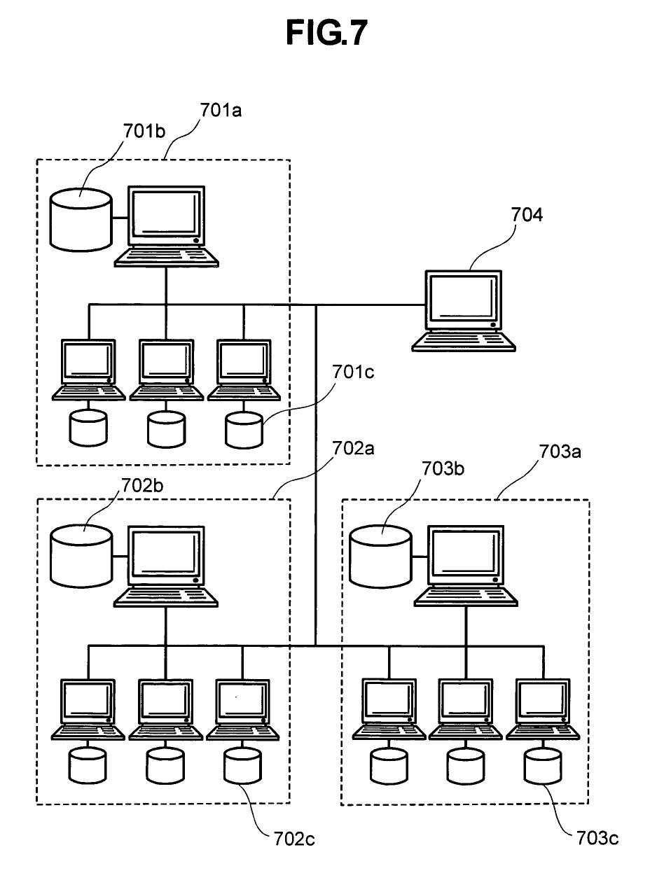

FIG. 7 shows the structure of the information search system, according to a second embodiment of the present invention. In the information search system of the present embodiment, there are index databases in plural numbers thereof, each being common to the users. In the example shown in FIG. 7, local systems 701, 702 and 703 are built up, in the similar structure of that shown in FIG. 1, and those local systems 701, 702 and 703 are connected to a communication network, in the structure thereof. The local system 701 is connected, in the structure thereof, at a data processing apparatus 701a for providing the index database 701b thereon, to a data processing apparatus 701d for providing the database 701c of the search target thereon, and the local systems 702 and 703 are also similar to that in the structure thereof. In such the system, using the data processing apparatus 704 for conducting the search operation, the user can conduct the search upon the databases through the index databases 701b, 702b and 703b. With such the structure of decentralizing the index databases, it is possible to reduce an amount of traffics on the network, in particular, when extracting the index information from the substantial database.

According to the present invention, the index within the index database is related to the index within the database of the search target, and the index database is built up through that relationship established. For this reason, it is possible for the user to build up the index database, freely, in which the indexes, each being expressed uniquely within the plural numbers of the substantial databases, can be treated uniformly through the system-use indexes. As a result of this, the database can be added to be the search target, easily, thereby to bring out superior expandability, and further improves availability of the index database method.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

1. An information search system, comprising:
plural numbers of databases, as a being a search target;
an index database, being built up by virtually unifying the plural numbers of the databases, in relation to an index thereof; and
a relationship means for relating an index within said index database to an index within said databases as the search target, wherein search is conducted onto said databases through said index database, and said index database is build up through the relationship made in said relationship means.

2. The information search system, as described in the claim 1, wherein a portion of said indexes of said index database is changeable into non-display in condition, selectively, when displaying a search result obtained within said index database.

3. The information search system, as described in the claim 1, wherein display can be made on an existence or non-existence of an access qualification to said databases as the search target, when displaying a search result obtained within said index database.

4. The information search system, as described in the claim 2, wherein display can be made on an existence or non-existence of an access qualification to said databases as the search target, when displaying a search result obtained within said index database.

5. The information search system, as described in the claim 1, wherein selection can be made on whether a personal-use database be included or not, within a target of obtaining indexes for said index database, if there are common-use databases to be used in common by a user group of plural numbers of users and also a personal-use database for use by an individual user, within said databases.

6. The information search system, as described in the claim 2, wherein selection can be made on whether a personal-use database be included or not, within a target of obtaining indexes for said index database, if there are common-use databases to be used in common by a user group of plural numbers of users and also a personal-use database for use by an individual user, within said databases.

7. The information search system, as described in the claim 3, wherein selection can be made on whether a personal-use database be included or not, within a target of obtaining indexes for said index database, if there are common-use databases to be used in common by a user group of plural numbers of users and also a personal-use database for use by an individual user, within said databases.

8. The information search system, as described in the claim 1, wherein narrowing on the databases of the search target can be made for an each user, within said databases of the search target.

9. The information search system, as described in the claim 2, wherein narrowing on the databases of the search target can be made for an each user, within said databases of the search target.

10. The information search system, as described in the claim 3, wherein narrowing on the databases of the search target can be made for an each user, within said databases of the search target.
